(19) United States
(12) Patent Application Publication
(10) Pub. No.: US 2026/0088609 A1
(43) Pub. Date: Mar. 26, 2026

(54) RF ESD PROTECTION CIRCUIT AND RF ESD PROTECTION SYSTEM

(71) Applicant: LUXIC TECHNOLOGY (GUANGZHOU) CO., LTD., Guangdong (CN)

(72) Inventors: Yun QI, Guangdong (CN); Yi CAO, Guangdong (CN); Jiawei XIAO, Guangdong (CN)

(21) Appl. No.: 19/333,706

(22) Filed: Sep. 19, 2025

(30) Foreign Application Priority Data
Sep. 20, 2024 (CN) 202411314851.3

(51) Int. Cl. H02H 9/04; H02H 9/00

(52) U.S. Cl. CPC H02H 9/045; H02H 9/005

(57) ABSTRACT

An RF ESD protection and system are provided. The RF ESD protection circuit includes a first NMOS transistor, a second NMOS transistor, a third NMOS transistor, a first RC network and a second RC network. The first NMOS transistor is formed in a deep N-well. The RF ESD protection circuit of this application can make the voltage at the connection point between the bulk and the source of the first NMOS transistor approach the difference between the gate voltage of the first NMOS transistor and the turn-on voltage of the first NMOS transistor. Thus, the gate-source voltage of the first NMOS transistor is close to its turn-on threshold voltage, without exceeding a maximum possible voltage that the gate of the first NMOS transistor can withstand, ensuring that the first NMOS transistor will not be burned out and is provided with desirable ESD protection.

### CROSS-REFERENCE TO RELATED APPLICATION

This application claims the priority of Chinese patent application number 202411314851.3, filed on Sep. 20, 2024 and entitled “RF ESD PROTECTION CIRCUIT AND RF ESD PROTECTION SYSTEM”, the entire contents of which are incorporated herein by reference.

### TECHNICAL FIELD

The present invention relates to the field of RF circuits and, in particular, to a radio frequency (RF) electrostatic discharge (ESD) protection circuit and an RF ESD protection system.

### BACKGROUND

Electrostatic discharge (ESD) has been recognized as one of the primary causes of failure of circuit components and integrated circuits. In order to provide the required performance, a radio frequency (RF) chip often incorporates a thin-gate transistor connected to the chips'I/O pin. However, the thin-gate transistor tends to be burned out upon a large current through the gate due to the thin-gate transistor's inferior voltage withstand capacity. Therefore, thin-gate transistors in RF chips are susceptible to ESD damage. The conventional ESD protection techniques cannot provide desirable ESD protection to thin-gate transistors.

### SUMMARY OF THE INVENTION

It is an object of the present invention to provide an RF ESD protection circuit and system, which overcome the problem that existing ESD protection techniques cannot provide good ESD protection to a thin-gate transistor in an RF chip.

To this end, in one aspect, the present invention provides an RF ESD protection circuit comprising a first NMOS transistor, a second NMOS transistor and a third NMOS transistor, the first NMOS transistor formed in a deep n-well.

The first NMOS transistor comprises a drain connected to an RF device, a gate connected to a signal port of an RF chip and a source connected to the drain of the second NMOS transistor, wherein the bulk of the first NMOS transistor is connected to the source of the first NMOS transistor and the source of the third NMOS transistor, wherein the second NMOS transistor comprises a source being grounded and a gate connected to a first power supply voltage via a first RC network, and wherein the third NMOS transistor comprises a drain connected to the first power supply voltage and a gate connected to a second power supply voltage via a second RC network.

Optionally, the first RC network comprises a first resistor and a first capacitor, the first terminal of the first resistor and the first terminal of the first capacitor connected to each other and then connected to the gate of the second NMOS transistor, the second terminal of the first resistor connected to the power supply voltage, the second terminal of the first capacitor being grounded.

Optionally, the second RC network comprises a second resistor and a second capacitor, the first terminal of the second resistor and the first terminal of the second capacitor connected to each other and then connected to the gate of the third NMOS transistor, the second terminal of the second resistor connected to the power supply voltage, the second terminal of the second capacitor being grounded.

Optionally, the RF device comprises a first PMOS transistor which comprises a gate connected to the signal port of the RF chip, a drain connected to the drain of the first NMOS transistor and a source coupled to the first or second power supply voltage.

Optionally, the source and the bulk of the first PMOS transistor are connected to the source of the third NMOS transistor.

Optionally, the RF ESD protection circuit further comprises a decoupling capacitor, and wherein the source of the third NMOS transistor is grounded through the decoupling transistor.

Optionally, the first and second power supply voltages can be the same power supply voltage. Alternatively, the first and second power supply voltages can be different power supply voltages, and the second power supply voltage may be provided by a linear regulator.

In another aspect, the present invention provides an RF ESD protection system comprising a power clamp circuit, a first diode, a second diode and the RF ESD protection circuit as defined above. The power clamp circuit is connected between the first power supply voltage and the ground. The anode of the first diode is grounded, and the cathode of the first diode is connected to the anode of the second diode. The cathode of the second diode is connected to the first power supply voltage, and the anode of the second diode is connected to the signal port of the RF chip.

Optionally, the power clamp circuit comprises a third resistor, a third capacitor, an inverter, a fourth NMOS transistor and a third diode, the first terminal of the third resistor connected to the first power supply voltage, the second terminal of the third resistor grounded via the third capacitor, the second terminal of the third resistor connected to an input terminal of the inverter, the output terminal of the inverter connected to the gate of the fourth NMOS transistor, the drain of the fourth NMOS transistor connected to the first power supply voltage, the source of the fourth NMOS transistor being grounded, the anode of the third diode being grounded, the cathode of the third diode connected to the first power supply voltage.

Optionally, the inverter comprises a second PMOS transistor and a fifth NMOS transistor, the source of the second PMOS transistor connected to the first power supply voltage, the source of the fifth NMOS transistor grounded, the gate of the second PMOS transistor and the gate of the fifth NMOS transistor connected to each other and providing the input terminal of the inverter, the drain of the second PMOS transistor and the drain of the fifth NMOS transistor connected to each other and providing an output terminal of the inverter.

In the RF ESD protection circuit as defined above, when ESD event occurs, for example, electrostatic discharge from the signal port of the chip to the ground, the first power supply voltage is clamped by the peripheral power clamp circuit within a safe voltage range. Moreover, due to the presence of the first RC network, the gate voltage of the second NMOS transistor is kept at zero, and the second NMOS transistor is OFF, throughout the discharge process. Thus, there is no return path for current through the gate of the first NMOS transistor to the ground, and voltage at the connection node of the bulk and the source of the first NMOS transistor rises as the gate voltage of the first NMOS transistor increases. Likewise, the gate voltage of the third NMOS transistor is also kept at zero, and the third NMOS transistor is OFF. Therefore, the source voltage of the third NMOS transistor rises as the bulk voltage of the first NMOS transistor increases. Thus, there is no return path for a current through the gate of the third NMOS transistor to the second power supply voltage, and the voltage at the connection node of the bulk and source of the first NMOS transistor is close to the difference between the gate voltage of the first NMOS transistor and turn-on threshold voltage thereof. Accordingly, the gate-source voltage of the first NMOS transistor is close to its turn-on threshold voltage, without exceeding a maximum possible voltage that the gate of the first NMOS transistor can withstand, ensuring that the first NMOS transistor will not be burned out and is provided with desirable ESD protection.

It should be noted that since the RF ESD protection system incorporates the RF ESD protection circuit, it has all the advantages of the circuit. For clarity and brevity, these advantages are not repeated herein.

### BRIEF DESCRIPTION OF THE DRAWINGS

Those of ordinary skill in the art will understand that the following drawings are presented to enable a better understanding of the present invention and not intended to limit the scope thereof in any sense, in which:

FIG. 1 shows a schematic diagram of a conventional ESD protection circuit;

FIG. 2 shows a schematic diagram of a power clamp circuit of the related art;

FIG. 3 shows a schematic diagram of an RF ESD protection system according to embodiments of the present invention;

FIG. 4 shows a schematic diagram of an RF ESD protection circuit according to embodiments of the present invention;

FIG. 5 shows another schematic diagram of the RF ESD protection circuit according to embodiments of the present invention; and

FIG. 6 shows another schematic diagram of the ESD protection system according to embodiments of the present invention.

### LIST OF REFERENCE NUMERALS

10—power clamp circuit; 20—protected circuit; 30—RF device; 40—linear regulator;
D1—first diode; D2—second diode; D3—third diode;
N1—first NMOS transistor; N2—second NMOS transistor; N3—third NMOS transistor; N4—fourth NMOS transistor; N5—fifth NMOS transistor; P1—first PMOS transistor; P2—second PMOS transistor;
R1—first resistor; R2—second resistor; R3—third resistor;
C1—first capacitor; C2—second capacitor; C3—third capacitor; C4—decoupling capacitor.

### DETAILED DESCRIPTION

Objects, advantages and features of the present invention will become more apparent upon reading the following more detailed description with reference to the accompanying drawings, which illustrate particular embodiments thereof. Note that the figures are provided in a very simplified form, not necessarily drawn to exact scale, for the purpose of helping to explain the disclosed embodiments in a more convenient and clearer way. In addition, the illustrated structures are part of real counterparts. In particular, as the figures tend to have distinct emphases, they are sometimes drawn to different scales.

As used herein, the singular forms “a”, “an” and “the” include plural referents, and the term “or” is generally employed in the sense of “and/or”, “a number of” is generally employed in the sense of “at least one”, and “at least two” is generally employed in the sense of “two or more”. Additionally, the use of the terms “first”, “second” and “third” herein is intended for illustration only and is not to be construed as denoting or implying relative importance or as implicitly indicating the numerical number of the referenced items. Accordingly, defining an item with “first”, “second” or “third” is an explicit or implicit indication of the presence of one or at least two such items. The terms “one end” and “the other end”, as well as “proximal end” and “distal end”, may be used herein to generally refer to corresponding end portions, rather than precisely to the endpoints. The terms “mounted”, “coupled”, “connected” and variants thereof should be interpreted in a broad sense. For instance, a connection may be a fixed, detachable or integral connection, or a mechanical or electrical connection, or a direct or indirect connection with one or more intervening media, or an internal communication or interaction between two elements. When an element is referred to herein as being “disposed” on another element, this is generally intended to only mean that there is a connection, coupling, engagement or transmission relationship between the two elements, which may be either direct or indirect with intervening elements, and should not be interpreted as indicating or implying a particular spatial position relationship between them. That is, the element may be located inside, outside, above, under, beside, or at any other location relative to the other element, unless the context clearly dictates otherwise. Those of ordinary skill in the art can understand the specific meanings of the above-mentioned terms herein, depending on their context.

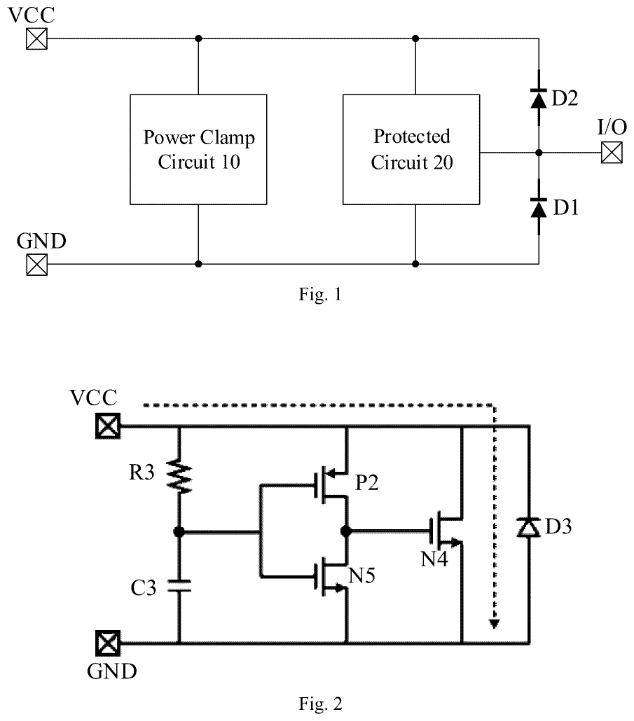

FIG. 1 shows a schematic diagram of a conventional electrostatic discharge (ESD) protection circuit. In FIG. 1, I/O is an input/output pin of a chip. A component in a protected circuit 20, which is directly connected to I/O, is in need of an ESD protection design. ESD protection is provided to the protected circuit 20 by two diodes (a first diode D1 and a second diode D2) and a power clamp circuit 10. The cathode of the second diode D2 is connected to a first power supply voltage, and the anode of the second diode D2 is connected to the protected circuit 20 and I/O. The cathode of the first diode D1 is connected to the protected circuit 20 and I/O, and the anode of the first diode D1 is grounded. When an ESD event occurs, the power clamp circuit 10 can clamp the first power supply voltage at a safe voltage (Vclamp), thereby providing ESD protection to the protected circuit 20.

FIG. 2 shows a schematic diagram of a power clamp circuit of the related art. In one embodiment, referring to FIG. 2, the power clamp circuit 10 includes a third resistor R3, a third capacitor C3, an inverter, a fourth NMOS transistor N4 and a third diode D3. The first terminal of the third resistor R3 is connected to a first power supply voltage, and the second terminal of the third resistor R3 is grounded via the third capacitor C3. The second terminal of the third resistor R3 is connected to an input terminal of the inverter, and an output terminal of the inverter is connected to the gate of the fourth NMOS transistor N4. The drain of the fourth NMOS transistor N4 is connected to the first power supply voltage, and the source of the fourth NMOS transistor N4 is grounded. The anode of the third diode D3 is grounded, and the cathode of the third diode D3 is connected to the first power supply voltage. When a sudden spike in the power supply voltage occurs due to charge buildup, the voltage at the connection node between the third resistor R3 and the third capacitor C3 will remain low because of the presence of the third resistor R3 and the third capacitor C3. In response to this low voltage being input to the inverter, the inverter outputs a high voltage, turning on the fourth NMOS transistor N4 and thereby creating a path, through which the charge in the first power supply voltage is discharged. In this way, despite possible occurrence of ESD events, the power clamp circuit 10 is able to clamp the first power supply voltage at a safe voltage (Vclamp), providing protection to the internal circuit components.

As an example, the inverter includes a second PMOS transistor P2 and a fifth NMOS transistor N5. The source of the second PMOS transistor P2 is connected to the first power supply voltage, and the source of the fifth NMOS transistor N5 is grounded. Gates of the second PMOS and fifth NMOS P2, N5 are connected to each other and provide the input terminal of the inverter, and the drains of the second PMOS and fifth NMOS P2, N5 are connected to each other and provide the output terminal of the inverter.

Referring to FIG. 1, as would be appreciated by a person skilled in the art, in response to an ESD event occurring at the I/O pin, there are four possible discharge paths: forward and reverse discharge from the I/O pin to the first power supply voltage; and forward and reverse discharge from the I/O pin to the ground. The forward discharge path from the I/O pin to the first power supply voltage is through the second diode D2, and the reverse discharge path from the I/O pin to the ground is through the first diode D1. If turn-on voltages of the first and second diodes D1, D2 are both Vdio, then a voltage arising from forward discharge from the I/O pin to the first power supply voltage will be +Vdio, and a voltage arising from reverse discharge from the I/O pin to the ground will be −Vdio. The reverse discharge path from the I/O pin to the first power supply voltage is through the power clamp circuit 10 and the first diode D1, and the forward discharge path from the I/O pin to the ground is through the second diode D2 and the power clamp circuit 10. As noted above, since the power clamp circuit 10 clamps the first power supply voltage at Vclamp, a voltage present at the I/O pin will be ±(Vclamp+Vdio).

In order to provide required performance, an RF circuit typically incorporates a thin-gate transistor with a gate being connected to an I/O pin, a source being grounded and a drain connected to an RF device 30 in the RF circuit (e.g., an inductor, an RF resistor, etc.) Therefore, devices connected to input/output (I/O) pins in RF circuits are susceptible to ESD damage. If a voltage presenting at the I/O pin is Vclamp+Vdio that is higher than a gate oxide breakdown voltage of a thin-gate transistor, the thin-gate transistor may be burned out upon the occurrence of an ESD event. Therefore, this conventional ESD protection circuit could not provide satisfactory protection to the thin-gate transistor that is fabricated using an advanced process.

Thus, conventional ESD designs could not well protect I/O pins in RF circuits, primarily because gates in thin-gate transistors fabricated using advanced processes are not able to withstand Vclamp+Vdio and may be burned out by large currents at the gate. In view of this, embodiments of the present invention provide an RF ESD protection circuit and system, which overcome the problem that existing ESD protection techniques cannot provide good ESD protection to a thin-gate transistor in an RF chip.

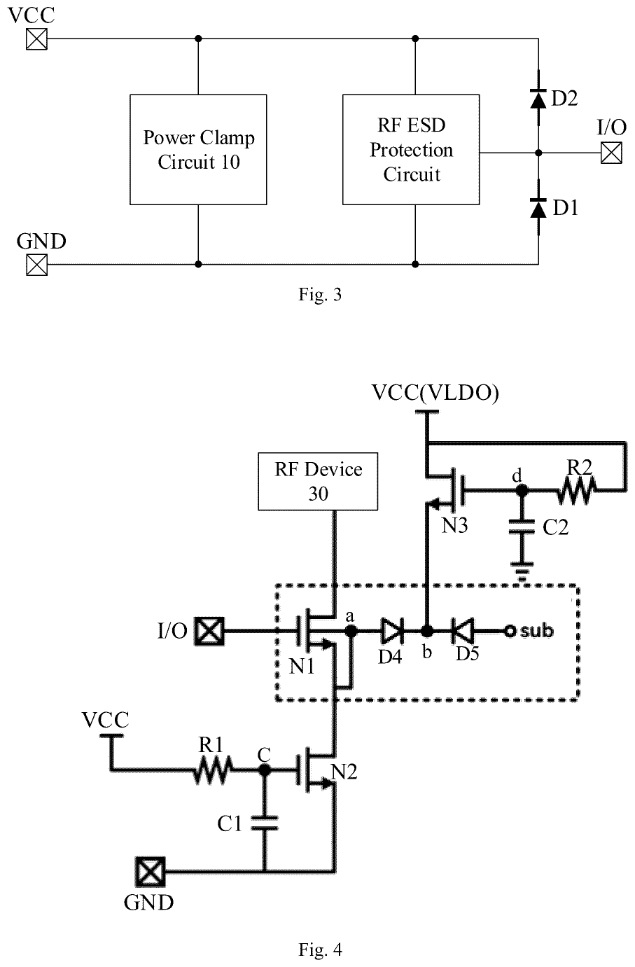

FIG. 3 shows a schematic diagram of an RF ESD protection system according to embodiments of the present invention. FIG. 4 shows a schematic diagram of an RF ESD protection circuit according to embodiments of the present invention. Referring to FIG. 3, the RF ESD protection system includes a power clamp circuit 10, a first diode D1, a second diode D2 and the RF ESD protection circuit. The power clamp circuit 10 is connected between the first power supply voltage and the ground. The anode of the first diode D1 is grounded, and the cathode of the first diode D1 is connected to the anode of the second diode D2. The cathode of the second diode D2 is connected to the first power supply voltage, and the anode of the second diode D2 is connected to the signal port (e.g., an I/O pin) of an RF chip. Referring to FIG. 4, the RF ESD protection circuit includes a first NMOS transistor N1, a second NMOS transistor N2 and a third NMOS transistor N3. The first NMOS transistor N1 is a thin-gate transistor formed in a deep N-well. The second NMOS transistor N2 and the third NMOS transistor N3 are both thick-gate transistors. The drain of the first NMOS transistor N1 is connected to an RF device 30, and the gate of the first NMOS transistor N1 is connected to the signal port of the RF chip. The source of the first NMOS is connected to the drain of the second NMOS transistor N2, and the bulk of the first NMOS transistor is connected to the source of the first NMOS transistor N1 and the source of the third NMOS transistor N3. The source of the second NMOS transistor N2 is grounded, and the gate of the second NMOS transistor N2 is connected to the first power supply voltage via a first RC network. The drain of the third NMOS transistor N3 is connected to the first power supply voltage, and the gate of the third NMOS transistor N3 is connected to the second power supply voltage via a second RC network. The first RC network includes a first resistor R1 and a first capacitor C1. The first terminal of the first resistor R1 and the first terminal of the first capacitor C1 are connected to each other and then connected to the gate of the second NMOS transistor N2. The second terminal of the first resistor R1 is connected to the power supply voltage, and the second terminal of the first capacitor C1 is grounded. The second RC network includes a second resistor R2 and a second capacitor C2. The first terminal of the second resistor R2 and the first terminal of the second capacitor C2 are connected to each other and then to the gate of the third NMOS transistor N3. The second terminal of the second resistor R2 is connected to the power supply voltage, and the second terminal of the second capacitor C2 is grounded. Parameters of the first and second RC networks should be appropriately selected so that voltages at nodes c and d remain almost unchanged even when ESD event occurs.

It is noted that the first power supply voltage as well as a normal value of the first power supply voltage is denoted as VCC, and the second power supply voltage as well as a normal value of the second power supply voltage is denoted as VLDO. The first and second power supply voltages can be the same power supply voltage. Alternatively, the first and second power supply voltages can be different power supply voltages, and the second power supply voltage can be provided, for example, by a linear regulator.

As shown in FIG. 4, taking discharge of electrostatic charge from I/O to the ground as example, the power clamp circuit 10 clamps the first power supply voltage at Vclamp. Due to the presence of the first RC network (i.e., of the first resistor R1 and the first capacitor C1), during the discharge, the voltage at the gate of the second NMOS transistor N2 (i.e., at node c) remains 0, and the second NMOS transistor N2 is OFF. That is, the second NMOS transistor N2 is equivalent to an open circuit. As a result, there is no return path for a current through the gate of the first NMOS transistor N1 to the ground, and a voltage at node a (e.g., at the bulk and source of the first NMOS transistor N1) rises as the voltage at the gate increases. Likewise, the voltage at the gate of the third NMOS transistor N3 (i.e., at the node d) remains 0, and the third NMOS transistor N3 is equivalent to an open circuit. Therefore, the voltage at node b rises as the voltage at node a increases. Consequently, a parasitic diode (D4) of the first NMOS transistor N1 remains OFF, and there is no return path for a current through the gate to VCC. For these reasons, the voltage at node a is close to Vclamp+Vdio−Vth1, where Vth1 represents a turn-on threshold voltage of the first NMOS transistor N1. Accordingly, the gate-source voltage of the first NMOS transistor N1, i.e., the thin-gate transistor, is close to Vth1, lower than the voltage that the gate of the thin-gate transistor can withstand, preventing the gate from being burned out.

During normal operation after power-up (without the occurrence of ESD events), the first power supply voltage is at the normal value VCC, and the voltages at nodes c and d are also equal to VCC. Accordingly, the gate-source voltage of the second NMOS transistor N2 is VCC, turning on the second NMOS transistor N2 and hence the third NMOS transistor N3. Consequently, the voltage at node b is VCC−Vth3, wherein Vth3 represents a turn-on threshold voltage of the third NMOS transistor N3. According to the required RF performance, the sizes of the second and third NMOS transistors N2, N3 and the first power supply voltage should be appropriately selected to prevent forward conduction of the first NMOS transistor N1, allowing for normal operation of the RF chip without being affected by the proposed ESD protection circuit.

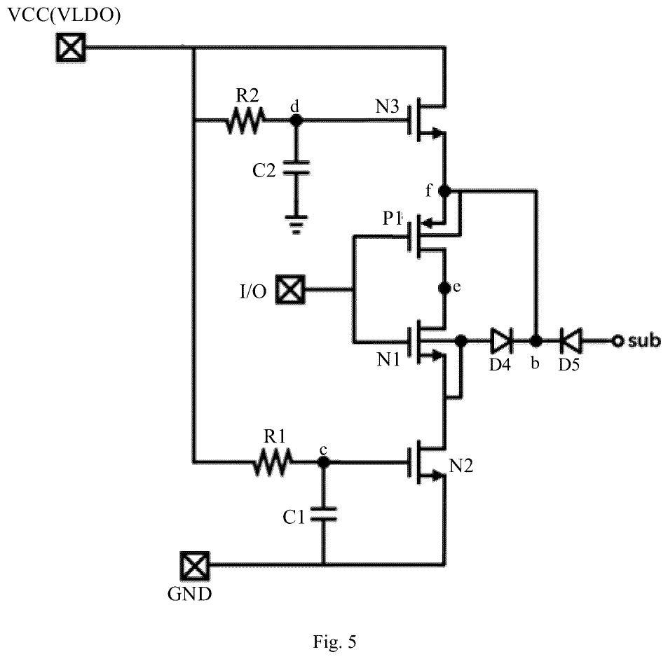

FIG. 5 shows another schematic diagram of the RF ESD protection circuit according to embodiments of the present invention. Referring to FIG. 5, the RF device 30 includes a first PMOS transistor P1, which is a thin-gate transistor. The gate of the first PMOS transistor P1 is connected to the signal port of the RF chip, and the drain of the first PMOS transistor P1 is connected to the drain of the first NMOS transistor N1. The source of the first PMOS transistor P1 is coupled to the first or second power supply voltage. With this arrangement, the first PMOS transistor P1 and the first NMOS transistor N1 form an inverter. Further, the source and the bulk of the first PMOS transistor P1 are connected to the source of the third NMOS transistor N3.

Before the first power supply voltage is made available, the voltage at the gate of the second NMOS transistor N2 is low, and the second NMOS transistor N2 is OFF. Moreover, the voltage at the gate of the third NMOS transistor N3 is also low, and the third NMOS transistor N3 is OFF. Thus, prior to power-up, each of nodes a, b, e, f is in a high-resistance state. In the event of the occurrence of an ESD event, the gate voltages of the first NMOS transistor N1 and the first PMOS transistor P1 are clamped at Vclamp+Vdio. Since there is no discharge path through either of the gates of the first NMOS transistor N1 and the first PMOS transistor P1, the voltages at nodes a, b, e, f all rise as the gate voltages increase, ensuring that neither of these gates is burned out by a large current, which arises from an excess voltage. Eventually, the gate voltages of the first NMOS transistor N1 and the first PMOS transistor P1 will drop as electrostatic charge is discharged.

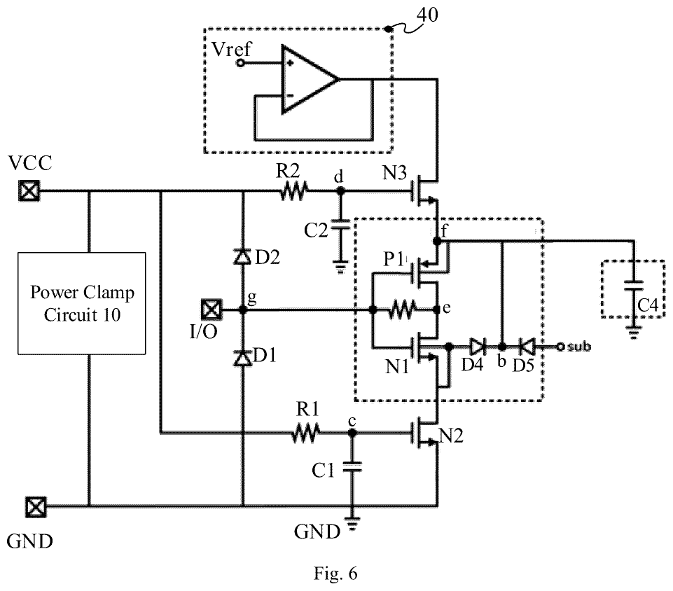

FIG. 6 shows another schematic diagram of the ESD protection system according to embodiments of the present invention. Referring to FIG. 6, the drain of the third NMOS transistor N3 is connected to the linear regulator 40, which can provide the second power supply voltage with a higher power supply rejection ratio (PSRR). During normal operation of the circuit, as an example, VCC may be 3.3 V, and the voltage output from the linear regulator 40 may be 1 V. Accordingly, the voltages at nodes c and d are 3.3 V, and the voltage at the drain of the first PMOS transistor P1 is 1 V. The first PMOS transistor P1 is turned on. Moreover, because of a large width-to-length ratio of the first PMOS transistor P1, its on-resistance is low, and the voltage at node f can be approximately 1 V. The voltage at node f can be provided as a power supply for an RF circuit. In this case, a decoupling capacitor C4 should be added to convert the high-frequency power supply at node f into an AC ground, in order for improved RF performance to be achieved. That is, the source of the third NMOS transistor N3 need to be grounded via the decoupling capacitor C4.

With continued reference to FIG. 6, forward discharge may occur from the I/O pin, i.e., from node g, to the ground through the second diode D2 and the power clamp circuit 10. In this case, the voltage at node g will be clamped at Vclamp+Vdio, and VCC will be clamped at Vclamp. As can be seen from the above analysis, when instantaneous ESD charges arrive, due to the presence of an RC delay consisting of R1, C1, R2 and C2, nodes c and d remain at 0 V, both the second and third NMOS transistor N2, N3 are OFF. Thus, there is no discharge path from the gate of either of the first NMOS transistor N1 and the first PMOS transistor P1 to the ground. Therefore, neither of these gates will be burned out by a large current, which arises from an excess voltage.

With continued reference to FIG. 6, reverse discharge may occur from the I/O pin, i.e., from node g, to VCC through the second diode D2 and the power clamp circuit 10. In this case, node g will be clamped at −(Vclamp+Vdio), with VCC being 0-V reference voltage and the ground being clamped at −Vclamp. As can be seen from the above analysis, when instantaneous ESD charges arrive, due to the presence of C1, C2 and the decoupling capacitor C4, the voltages at nodes c, d and f follow the ground and transition to −Vclamp, and both the second and third NMOS transistor N2, N3 are OFF. Thus, there is no discharge path from the gate of either of the first NMOS transistor N1 and the first PMOS transistor P1 to VCC. Therefore, neither of these gates will be burned out by a large current, which arises from an excess voltage.

It will be recognized that while the invention has been described above with reference to preferred embodiments thereof, it is not intended to be limited to these embodiments. In light of the above teachings, any person familiar with the art may make many possible modifications and variations to the disclosed embodiments or adapt them into equivalent embodiments, without departing from the scope of the invention. Accordingly, it is intended that any simple variations, equivalent changes and modifications made to the foregoing embodiments based on the substantive disclosure of the invention without departing from the scope thereof fall within this scope.

What is claimed is:

1. A radio frequency (RF) electrostatic discharge (ESD) protection circuit, comprising a first NMOS transistor, a second NMOS transistor and a third NMOS transistor, wherein the first NMOS transistor is formed in a deep N-well,
wherein the first NMOS transistor comprises a drain connected to an RF device, a gate connected to a signal port of an RF chip and a source connected to a drain of the second NMOS transistor, wherein a bulk of the first NMOS transistor is connected to the source of the first NMOS transistor and a source of the third NMOS transistor, wherein the second NMOS transistor comprises a source being grounded and a gate connected to a first power supply voltage via a first RC network, and wherein the third NMOS transistor comprises a drain connected to the first power supply voltage and a gate connected to a second power supply voltage via a second RC network.

2. The RF ESD protection circuit according to claim 1, wherein the first RC network comprises a first resistor and a first capacitor, wherein a first terminal of the first resistor and a first terminal of the first capacitor are connected to each other and then are connected to the gate of the second NMOS transistor, wherein a second terminal of the first resistor is connected to the power supply voltage, and wherein a second terminal of the first capacitor is grounded.

3. The RF ESD protection circuit according to claim 1, wherein the second RC network comprises a second resistor and a second capacitor, wherein a first terminal of the second resistor and a first terminal of the second capacitor are connected to each other and then are connected to the gate of the third NMOS transistor, wherein a second terminal of the second resistor is connected to the power supply voltage, and wherein a second terminal of the second capacitor is grounded.

4. The RF ESD protection circuit according to claim 1, wherein the RF device comprises a first PMOS transistor comprising a gate connected to the signal port of the RF chip, a drain connected to the drain of the first NMOS transistor and a source coupled to the first or second power supply voltage.

5. The RF ESD protection circuit according to claim 4, wherein the source and a bulk of the first PMOS transistor are connected to the source of the third NMOS transistor.

6. The RF ESD protection circuit according to claim 5, further comprising a decoupling capacitor, and wherein the source of the third NMOS transistor is grounded through the decoupling transistor.

7. The RF ESD protection circuit according to claim 1, wherein the first and second power supply voltages are a same power supply voltage.

8. The RF ESD protection circuit according to claim 1, wherein the first and second power supply voltages are different power supply voltages, and wherein the second power supply voltage is provided by a linear regulator.

9. A radio frequency (RF) electrostatic discharge (ESD) protection system, comprising a power clamp circuit, a first diode, a second diode and the RF ESD protection circuit of claim 1, wherein the power clamp circuit is connected between the first power supply voltage and the ground, wherein the first diode comprises an anode being grounded and a cathode connected to an anode of the second diode, and wherein the second diode comprises a cathode connected to the first power supply voltage and the anode connected to the signal port of the RF chip.

10. The RF ESD protection system according to claim 9, wherein the power clamp circuit comprises a third resistor, a third capacitor, an inverter, a fourth NMOS transistor and a third diode, wherein the third resistor comprises a first terminal connected to the first power supply voltage and a second terminal that is connected to an input terminal of the inverter and is grounded via the third capacitor, wherein an output terminal of the inverter is connected to a gate of the fourth NMOS transistor, and wherein the fourth NMOS transistor comprises a drain connected to the first power supply voltage and a source being grounded, and wherein the third diode comprises an anode being grounded and a cathode connected to the first power supply voltage.

11. The RF ESD protection system according to claim 9, wherein the inverter comprises a second PMOS transistor and a fifth NMOS transistor, wherein a source of the second PMOS transistor is connected to the first power supply voltage, wherein a source of the fifth NMOS transistor is grounded, wherein a gate of the second PMOS transistor and a gate of the fifth NMOS transistor are connected to each other and provide the input terminal of the inverter, and wherein a drain of the second PMOS transistor and a drain of the fifth NMOS transistor are connected to each other and provide an output terminal of the inverter.
